(19) United States
(12) Patent Application Publication
(10) Pub. No.: US 2014/0200495 A1
(43) Pub. Date: Jul. 17, 2014

(54) MASSAGING SYSTEM AND METHOD

(71) Applicant: Innovative Standards, Inc., Lenexa, KS (US)

(72) Inventor: Daniel W. Jones, Overland Park, KS (US)

(73) Assignee: Innovative Standards, Inc., Lenexa, KS (US)

(21) Appl. No.: 14/218,968

(22) Filed: Mar. 18, 2014

Related U.S. Application Data
(63) Continuation-in-part of application No. 13/864,036, filed on Apr. 16, 2013.
Application No. 13/864,036 is a continuation of application No. 13/479,716, filed on May 24, 2012, now Pat. No. 8,418,298.
Application No. 13/479,716 is a continuation of application No. 12/731,404, filed on Mar. 25, 2010, now Pat. No. 8,201,293.
Application No. 12/731,404 is a continuation of application No. 11/504,406, filed on Aug. 15, 2006, now Pat. No. 7,712,172.
(60) Provisional application No. 61/799,810, filed on Mar. 15, 2013.

(51) Int. Cl. A61H 15/00

(52) U.S. Cl. CPC A61H 15/0078
USPC 601/98

(57) ABSTRACT

A massaging system and method that includes a base carrying a massager head, carriage and drive arrangement resiliently biased by a massager suspension arrangement formed by part of a resilient deformable person support disposed between the massager head and a person supporting surface upon which a person being massaged by the massaging system. The massager suspension arrangement is formed by part of the resilient deformable person support that can be formed of foam, preferably memory foam, which provides or defines a spring of the suspension arrangement capture in compression.

### CROSS REFERENCE

This application claims priority in U.S. Provisional Patent Application No. 61/799,810, filed Mar. 15, 2013, the entirety of which is hereby expressly incorporated herein by reference, and is a continuation-in-part of U.S. application Ser. No. 13/864,036 filed Apr. 16, 2013, which is a continuation of U.S. application Ser. No. 13/479,716 filed May 24, 2012, which issued Apr. 16, 2013 as U.S. Pat. No. 8,418,298, which is a continuation of U.S. application Ser. No. 12/731,404 filed Mar. 25, 2010, which issued Jun. 19, 2012 as U.S. Pat. No. 8,201,293, which in turn is a continuation of U.S. application Ser. No. 11/504,406, filed Aug. 15, 2006, which issued May 11, 2010 as U.S. Pat. No. 7,712,172.

### FIELD

The present invention is directed to a massaging system and method for massaging a person whose location can be approximate and more particularly to a massaging system and method for doing so that is adaptable to a sleep system, therapeutic treatment apparatus, and the like.

### BACKGROUND

While there are many types of massaging chairs and hand-held massagers, massaging pads and the like, attempts to make a massaging sleep system have met with limited commercial success in the past. It is not surprising because producing such a sleep system is a rather complicated endeavor because it is difficult to accurately and repeatably locate a person laying on a mattress of a massaging sleep system relative to massaging elements of the sleep system, much less specific parts of the body of a person laying on the mattress.

Producing a massaging chair is far less complicated because the chair is contoured in a manner that serves as a fixture for a person sitting in the chair positioning the various massaging elements of the chair relative to where each arm, leg, buttocks, back, shoulders and the like of the person are located when sitting in the chair. Likewise, a hand-held massager is precisely located relative to the person being massaged by the user maneuvering each massaging element of the massager over the desired part of the person's body.

What is needed is a massager or massaging arrangement formed of one or more massaging elements that effectively massages one or more persons including when the location or position of various body parts is not known nor fixtured. What is also needed is a sleep system that also provides massage for one or more persons prone or laying on a mattress of the sleep system.

### SUMMARY

The present invention is directed to a massaging system and method that includes a base carrying a massager head, carriage and drive arrangement resiliently biased by a massager suspension arrangement formed by part of a resilient deformable person support disposed between the massager head and a person supporting surface upon which a person being massaged by the massaging system. The massager suspension arrangement is formed by part of the resilient deformable person support that can be formed of foam, preferably memory foam, which provides or defines a spring of the suspension arrangement capture in compression.

These and other objects, features and advantages of this invention will become apparent from the following detailed description of the invention and accompanying drawings.

### DRAWING DESCRIPTION

FIG. 1 is a perspective view of a massaging bed equipped with a pair of massaging systems according to the present invention;

FIG. 2 illustrates a modular mattress assembly capable of use as a mattress of the massaging bed of FIG. 1;

FIG. 3 is a top plan view of a base of the massaging bed with the mattress removed;

FIG. 4 is a top plan view of the massaging bed with a resilient person supporting surface and resilient person support removed;

FIG. 5 is a fragmentary enlarged perspective view of a massager head supported on part of a resilient support of the mattress providing an upper massager head suspension arrangement;

FIG. 6 is an enlarged top plan view of the massager head of FIG. 5;

FIG. 7 is an enlarged fragmentary front elevation view of the massager head of FIG. 5;

FIG. 8 is an enlarged fragmentary side elevation view of the massager head of FIG. 5;

FIG. 9 is a longitudinal cross-section view of the massaging bed of FIG. 1; and

FIG. 10 is a transverse cross-section view of the massaging bed of FIG. 1.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

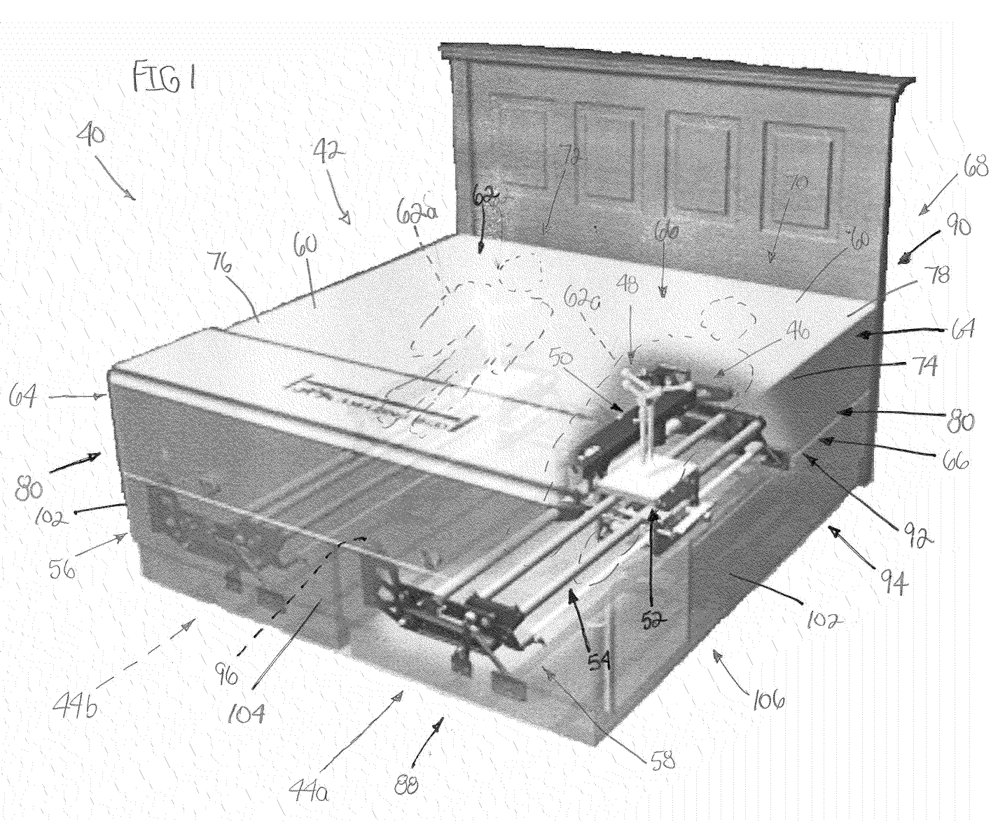

FIGS. 1-10 illustrate a piece of massaging furniture 40 that preferably is a massaging sleep system or massaging bed 42 equipped with a massaging system 44a, 44b constructed in accordance with the present invention having a massager 46 with a massager head 48 carried by an elongate massager actuator arrangement 50 extending outwardly from a massager carriage 52 that is movable along a massager guide 54 that is mounted to a base 56 by a displaceable massager mounting arrangement 58 that permits displacement of the massager head 48 relative to the base 56 and/or an outer surface 60 upon which a person 62a (shown in phantom in FIG. 1) being massaged is supported during massaging system operation. The massager head 48 is disposed within a resilient person support 64 that not only resiliently supports a person 62a on the person supporting surface 60 but which also functions as a massager suspension arrangement 66 that resiliently supports the massager head 48 permitting displacement of the massager head 48 relative to the base 56 and/or person supporting surface 60 in a manner that maintains massaging action coupling between the massager head 48 and the person 62a on the person supporting surface 60 during massaging system operation.

Such a massaging system 44a constructed in accordance with the present invention is disposed within a piece of furniture, i.e., massaging furniture 40, which provides massaging wave(s), massaging vibration(s), and/or massaging displacement(s) that reach the person support surface 60 upon which a person 62a is resting, sitting, laying, e.g., laying prone, or lying thereby massaging the person 62 during massaging system operation. The massaging furniture 40 shown in the drawing figures is a massaging sleep system or massaging bed 68 that is shown in FIG. 1 as being equipped with a plurality of massaging systems 44a, 44b with a first massaging system 44a disposed in one side or half 70 that massages one person 62a sitting, resting, lying or laying on the part of the person support surface 60 overlying the first massaging system 44a and a second massaging system 44b disposed in the other side or half 72 that massages another person 62b sitting, resting, lying or laying on the part of the person support surface 60 overlying the second massaging system 44b. The massaging systems 44a, 44b are disposed side-by-side alongside one another generally parallel to one another enabling both massaging systems 44a, 44b to be used substantially simultaneously.

Where the piece of massaging furniture 40 is a massaging bed 42, such a massaging bed can be configured with a plurality of independently operable and independently controllable massaging systems 44a, 44b to substantially simultaneously and yet independently massage a plurality of different people 62a, 62b at a time resting, sitting, lying, or laying on a respective part of the person support surface 60 of the massaging bed 42. Such a multiple-person massaging bed equipped with a plurality of such massaging systems 44a, 44b can be a double bed, a full bed, a wide double bed, a queen bed, an Olympic queen bed, a king bed, a super king bed, a California king bed, or even a king long bed if desired. Depending on the length and width of such a massaging bed, it can be equipped with a plurality of pairs, i.e., at least three, of massaging systems 44a, 44b (only two of which are depicted in FIG. 1) that can be and preferably are independently operable and independently controllable.

Where the piece of massaging furniture 40 is a smaller massaging sleep system or massaging bed constructed in accordance with the present invention is a smaller single bed, a twin bed, or even a therapeutic bed, e.g., a chiropractic or spa massaging bed, such a massaging bed can be equipped with only a single massaging system, e.g., massaging system 44a, if desired. If desired, a massaging system 44a constructed in accordance with the present invention can be used with other types of massaging furniture including a chair, a recliner, a rocker recliner, a power recliner, a sofa, a loveseat, movie seating, stadium seating, or another piece of furniture where the massaging system, e.g., massaging system 44a, is disposed within a piece of massaging furniture which has a person supporting surface 60 in operable communication with a massaging system 44a constructed in accordance with the present invention as described herein providing a massaging action to at least one person supported by or on the person supporting surface 60 during massaging system operation.

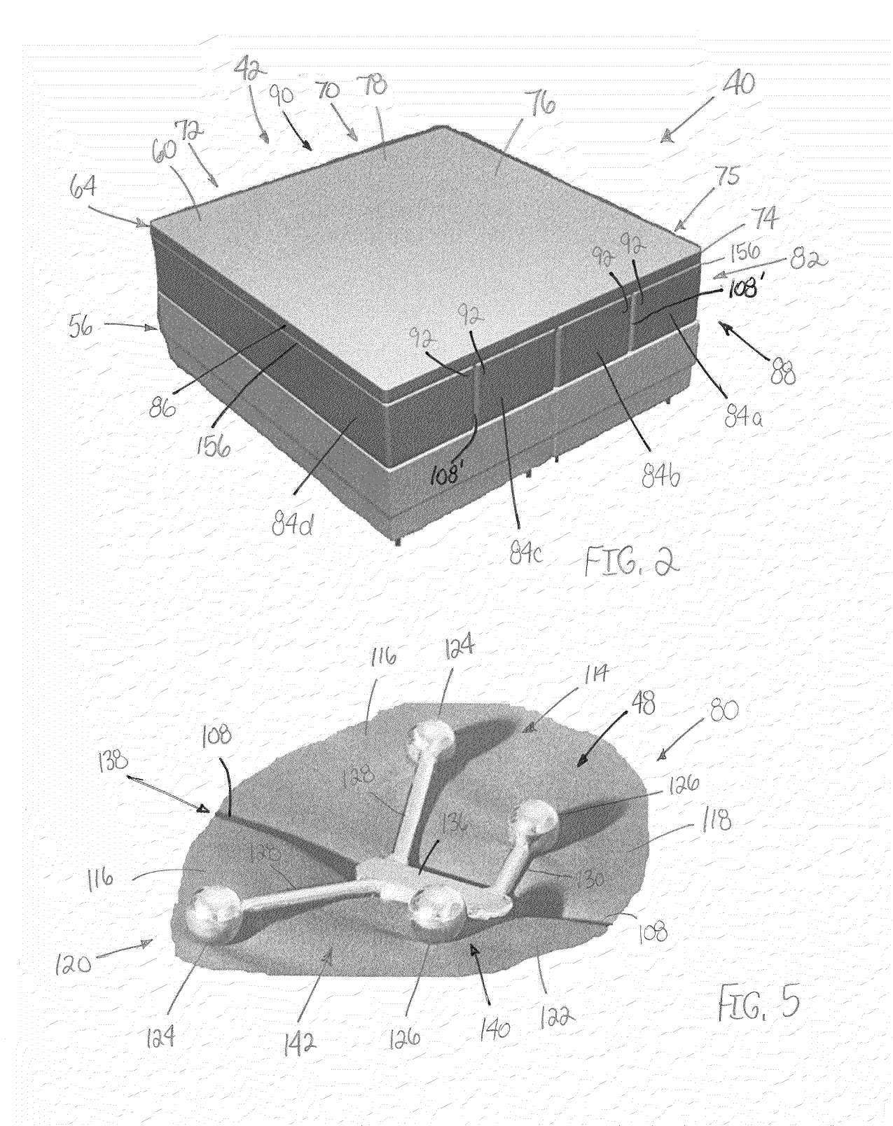

A piece of massaging furniture 40 equipped with at least one massaging system 44a constructed in accordance with the present invention has a person supporting surface 60 and a resilient person support 64 disposed between the massaging system 44a and a person 62a sitting, resting, lying or laying on the person supporting surface 60. The person supporting surface 60 preferably is generally planar or substantially flat or has a generally planar or substantially flat portion when not supporting a person thereon. As is discussed in more detail below, the resilient person support 64 preferably is compressible and/or deformable to not only provide comfort but also provides massager head coupling between a person resting, sitting, lying, or laying on the person supporting surface 60 and the massager head 48 during massaging system operation. As such the person supporting surface 60 can also be deformable and/or deflectable because it overlies and is supported by a compressible and/or deformable resilient person support 64 extending between the person supporting surface 60 and the massager head 48.

Where the piece of massaging furniture 40 is a massaging sleep system or massaging bed 42, at least a portion, preferably a substantial portion, of the person supporting surface 60 can be and preferably is generally horizontal as shown in FIGS. 1 and 2. With specific reference to FIG. 2, the person supporting surface 60 overlies a compressible and/or deformable comfort providing resilient person support 64 that can be a layer of compressible and/or deformable material 74 disposed between the massager head 48 and the person supporting surface 60. Such a layer of resilient compressible and/or deformable material 74 forming such a resilient person support 64 can be a cushion, a layer of padding, or another type of resilient compressible and/or deformable support layer disposed between the massager head 48 and the person supporting surface 60. Where the piece of massaging furniture 40 is a massaging sleep system or massaging bed 42, the layer of resilient compressible and/or deformable material 74 defining the resilient person support 64 is a portion of a mattress, a mattress topper, or a layer of resilient compressible and/or deformable material that provides a layer of cushioning or compliant supporting material between the massaging head 48 and the person supporting surface 60.

With continued reference to FIGS. 1 and 2, the exemplary but preferred furniture for which one or more massaging systems 44a, 44b of the invention are well suited for use is a massaging sleep system or massaging bed 42 that can be a single bed, twin bed, double bed, full bed, queen bed, or king bed. The massaging sleep system or massaging bed 42 shown in FIGS. 1 and 2 is a double bed, full bed, queen bed, or king bed constructed to hold a plurality of persons 62a, 62b (shown in phantom in FIG. 1) resting or laying down on an outer or top surface 76 of the massaging bed 42 that serves as a person supporting surface 60 therefor. The person supporting surface 60 is generally planar when not supporting any person thereon forming a top or upper surface 78 of a mattress 80, such as is depicted in FIG. 1, or a portion of a mattress assembly 82, such as is depicted in FIG. 2, formed of a resilient compressible and/or deformable material that preferably includes at least one layer of flexible, deformable and compressible material 74 disposed between the massager head 48 of each massaging system 44a, 44b and the person supporting surface.

When a person 62a and/or 62b sits down, kneels on, rests, lays or otherwise lies on part of the person supporting surface 60, the person supporting surface 60 depresses, deforms and/or compresses in response thereto at least partially respectively conforming to the shape and/or three dimensional contour of the person(s) 62a and/or 62b sitting, kneeling, resting, lying, or otherwise laying thereon. When a person 62a and/or 62b sits down, kneels on, rests, lays or otherwise lies on part of the person supporting surface 60, the underlying resilient person support 64 also accordingly depresses, deforms and/or compresses in response thereto at least partially respectively conforming to the shape and/or three dimensional contour of the person(s) 62a and/or 62b sitting, kneeling, resting, lying or otherwise laying thereon.

With reference to FIG. 1, where the massaging bed 42 employs a mattress 80, at least a portion of the massaging head 48 and/or the massager actuator arrangement 50 is embedded within the mattress 42 with the mattress 42 configured to permit movement of the massager head 48 within the mattress 42 relative to the person supporting surface 60 in a direction generally parallel thereto. Such a mattress 80 can be of one piece unitary and substantially homogeneous construction such as a one piece unitary and substantially homogeneous mattress 80 formed of foam, preferably an open cell or closed cell foam, which can be memory foam. If desired, the mattress 80 can be of one-piece construction having a layer 74 overlying the massaging head 48 that is formed of foam, such as an open cell or closed cell foam, which can be and preferably is memory foam.

Where the mattress 80 or any portion of the mattress 80 of a massaging bed 42 constructed in accordance with the present invention is made of a memory foam, such a memory foam is a viscoelastic polyurethane foam that preferably is a low-resilience polyurethane foam having a density of at least 1 pound per cubic foot that preferably is between 1 pound per cubic foot and 6 pounds per cubic foot. In a preferred mattress embodiment, the resilient person support 64 is formed of memory foam providing a viscoelastic massaging action coupling between the massager head arrangement and the person supporting surface that more efficiently conducts, transmits or otherwise conveys massaging wave(s), vibration(s) and/or massaging displacement(s) therebetween more efficiently and more comfortably massaging a person kneeling, sitting, resting, lying or laying on the mattress 80.

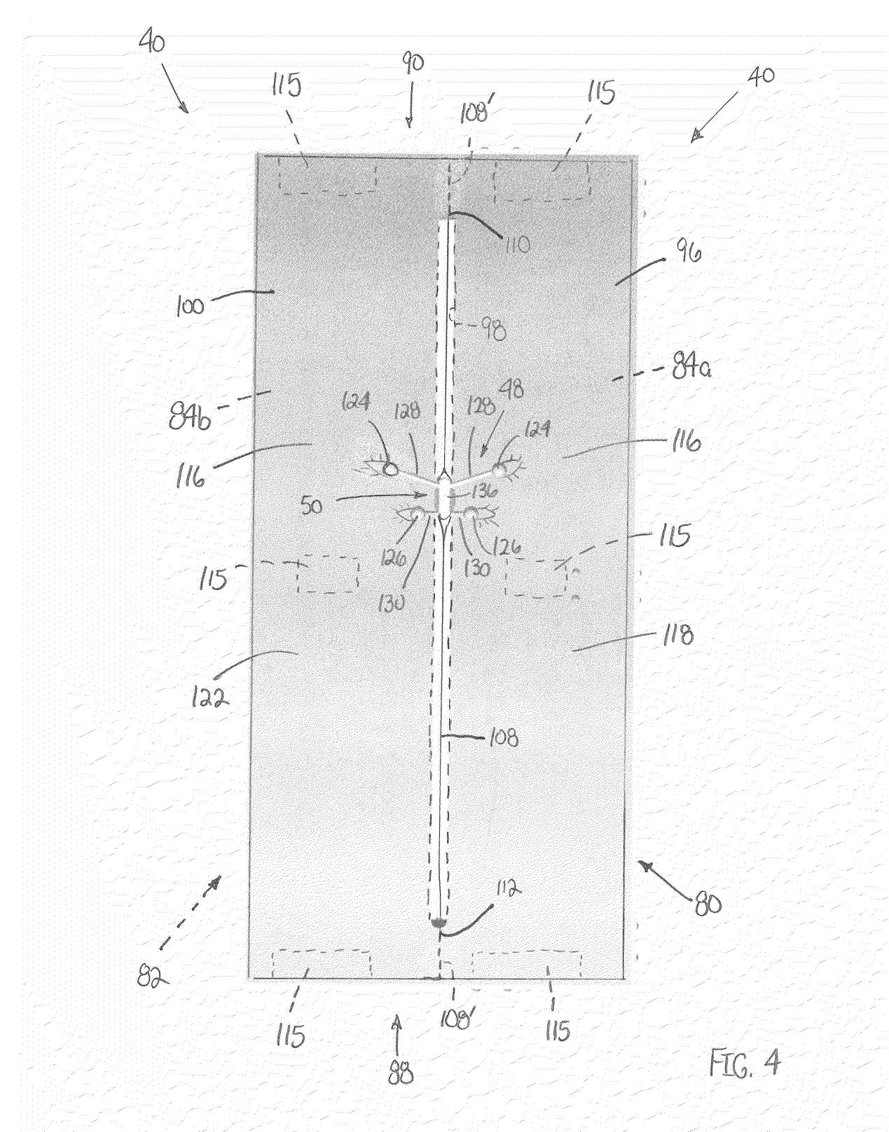

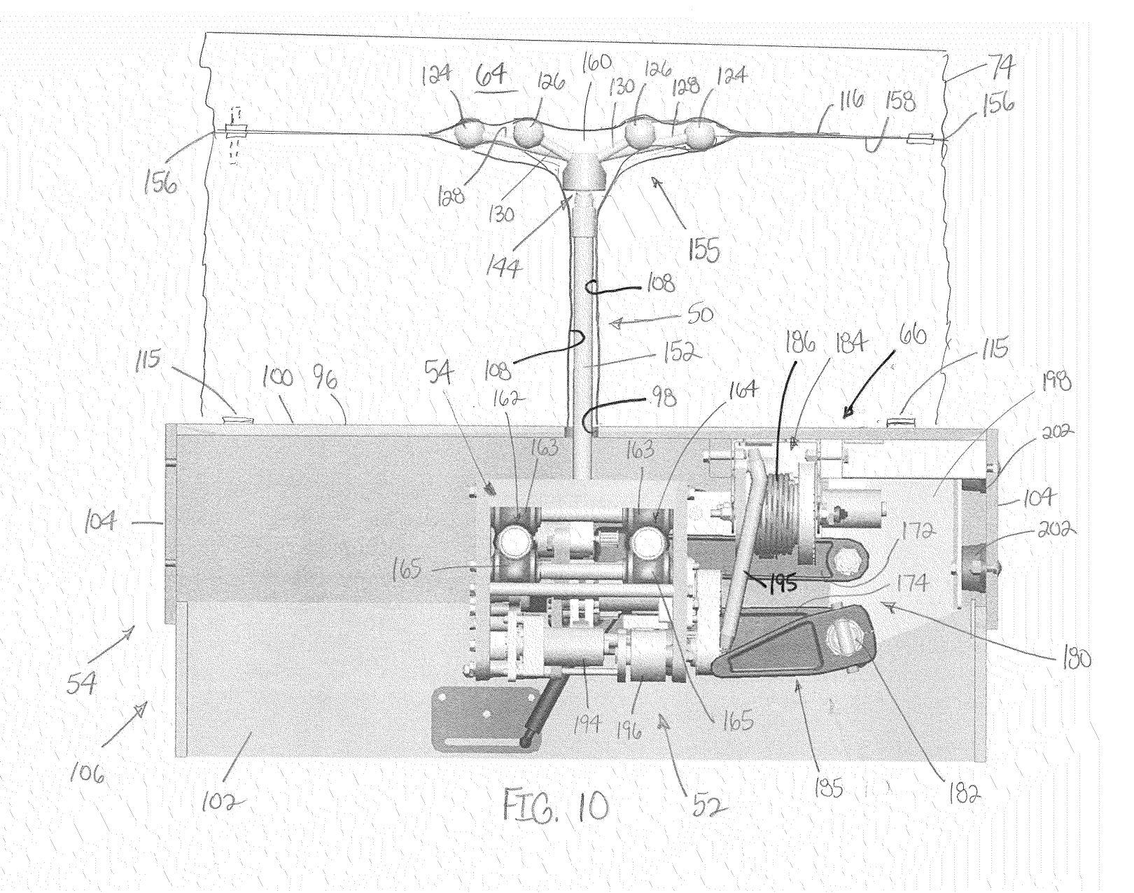

As discussed in more detail herein, the massager head arrangement 50 and at least part of the massager actuator arrangement of each massaging system 44a and/or 44b is embedded within such a mattress 80 with the mattress 80 having an elongate longitudinally extending generally T-shaped passage 155 (FIG. 10) formed therein in which the massager head arrangement 50 and at least part of the massager actuator arrangement can travel by moving within the mattress 80 relative to the person supporting surface. In a preferred embodiment, such a T-shaped passage 155 is formed of a generally vertically extending slit 108 (FIG. 4) and at least one generally horizontal slit 156 (FIGS. 9 and 10) that can and preferably does respectively open during passage of the massager actuator arrangement and massager head arrangement therethrough and which can and preferably does substantially close behind the massager actuator arrangement and massager head arrangement after passage therethrough.

As is also discussed herein, a portion of the mattress 80 underlying the massager head 48 on either side of the massager actuator arrangement 50 resiliently supports the massager head 48 functioning as a spring 92 of the massager suspension arrangement 66 formed of part of the mattress 80 that permits vertical displacement of the massager head 48 and massager actuator arrangement 50 relative to one of the base 56 and person supporting surface 60 during massaging system operation. By using part of a resilient person support, in this case part of the mattress 80 underlying the massager head 48, as at least part of a massager suspension arrangement 66 to help resiliently support the massager head 48 while it travels relative to the person supporting surface 60 toward or away from a foot 88 or head 90 of the bed 42, the massager head 48 is better able to follow the three-dimensional contour or shape of a person resting, sitting, laying, e.g., laying prone, or lying on the bed 42.

Where formed at least in part of memory foam, such a spring 92 is provided by at least a portion of the memory foam mattress 80 underlying the massager head 48 on either side of the massager actuator arrangement 50 captured in compression defining spring 92 that is captured in compression between the massager head 48 and base 56. Where the resilient person support 64 above and/or overlying the massager head 48 is formed of memory foam, such a contour hugging “floating” massaging system suspension arrangement 66 advantageously also helps maintain viscoelastic massaging action coupling between the massager head 48 and the person supporting surface 60 via the memory foam of the resilient person support 64 extending therebetween.

With reference to FIG. 2, where the massaging bed 42 employs a mattress assembly 82, a plurality of mattress blocks 84a, 84b, 84c, and 84d can be and preferably are supported on the base 56 with the resilient person support 64 formed of a pad 86, e.g., mattress pad 86, which provides the resilient person supporting layer 74 overlying the massager head 48 of each massaging system 44a and/or 44b of the massaging bed 42. Each mattress block 84a, 84b, 84c, and 84d preferably is elongate with its longest or lengthwise extent extending longitudinally relative to the massaging bed 42 from adjacent the foot 88 of the bed 42 toward the head 90 of the bed 42. Each mattress block 84a, 84b, 84c, and 84d preferably has a generally rectangular, e.g., square, transverse cross-section and preferably has a generally rectangular longitudinal cross-section. Although the massaging systems 44a and 44b are not shown in FIG. 2, one of the mattress blocks 84a is disposed on one side of the massager actuator arrangement 50 underlying one part of the massager head 48 of massaging system 44a and another one of the mattress blocks 84b is disposed on the other side of the massager actuator arrangement 50 underlying another part of the massager head 48 of massaging system 44a. Likewise, one of the mattress blocks 84c is disposed on one side of the massager actuator arrangement 50 underlying one part of the massager head 48 of massaging system 44b and another one of the mattress blocks 84d is disposed on the other side of the massager actuator arrangement 50 underlying another part of the massager head 48 of massaging system 44b.

In a preferred mattress assembly embodiment, each one of the mattress blocks 84a, 84b, 84c, and 84d is of one-piece, unitary and substantially homogeneous construction preferably being formed of a foam, such as an open cell or closed cell foam, which can be and preferably is a memory foam. Where the mattress blocks are each made of memory foam, such a memory foam is a viscoelastic polyurethane foam that preferably is a low-resilience polyurethane foam having a density of at least 1 pound per cubic foot that preferably is between 1 pound per cubic foot and 6 pounds per cubic foot. In a preferred mattress assembly embodiment, the resilient person support 64 is a mattress topper also formed of memory foam providing a viscoelastic massaging action coupling between the massager head arrangement and the person supporting surface that more efficiently conducts, transmits or otherwise conveys massaging wave(s), vibration(s) and/or massaging displacement(s) therebetween more efficiently and more comfortably massaging a person kneeling, sitting, resting, lying or laying on the mattress assembly 82.

A portion of each pair of adjacent mattress blocks 84a and 84b underlying the massager head 48 on either side of the massager actuator arrangement 50 of massaging system 44a resiliently supports the massager head 48 functioning as a spring 92 of the massager suspension arrangement 66 formed of part of such as mattress assembly 82 that permits vertical displacement of the massager head 48 and massager actuator arrangement 50 relative to one of the base 56 and person supporting surface 60 during massaging system operation. By using part of a resilient person support, in this case a portion of each pair of adjacent mattress blocks 84a and 84b underlying the massager head 48, as at least part of massager suspension arrangement 66 to help resiliently support the massager head 48 while it travels relative to the person supporting surface 60 toward or away from the foot or head of the bed 42, the massager head 48 is better able to follow the three-dimensional contour or shape of a person resting, sitting, laying, e.g., laying prone, or lying on the bed 42.

Where formed at least in part of memory foam, such a spring 92 is provided by at least a portion each pair of adjacent mattress blocks 84a and 84b underlying the massager head 48 on either side of the massager actuator arrangement 50 captured in compression defining spring 92 that is captured in compression between the massager head 48 and base 56. Where the resilient person support 64 above and/or overlying the massager head 48 is formed of memory foam, such a contour hugging “floating” massaging system suspension arrangement 66 also helps maintain viscoelastic massaging action coupling between the massager head 48 and the person supporting surface 60 via the memory foam of the resilient person support 64 extending therebetween.

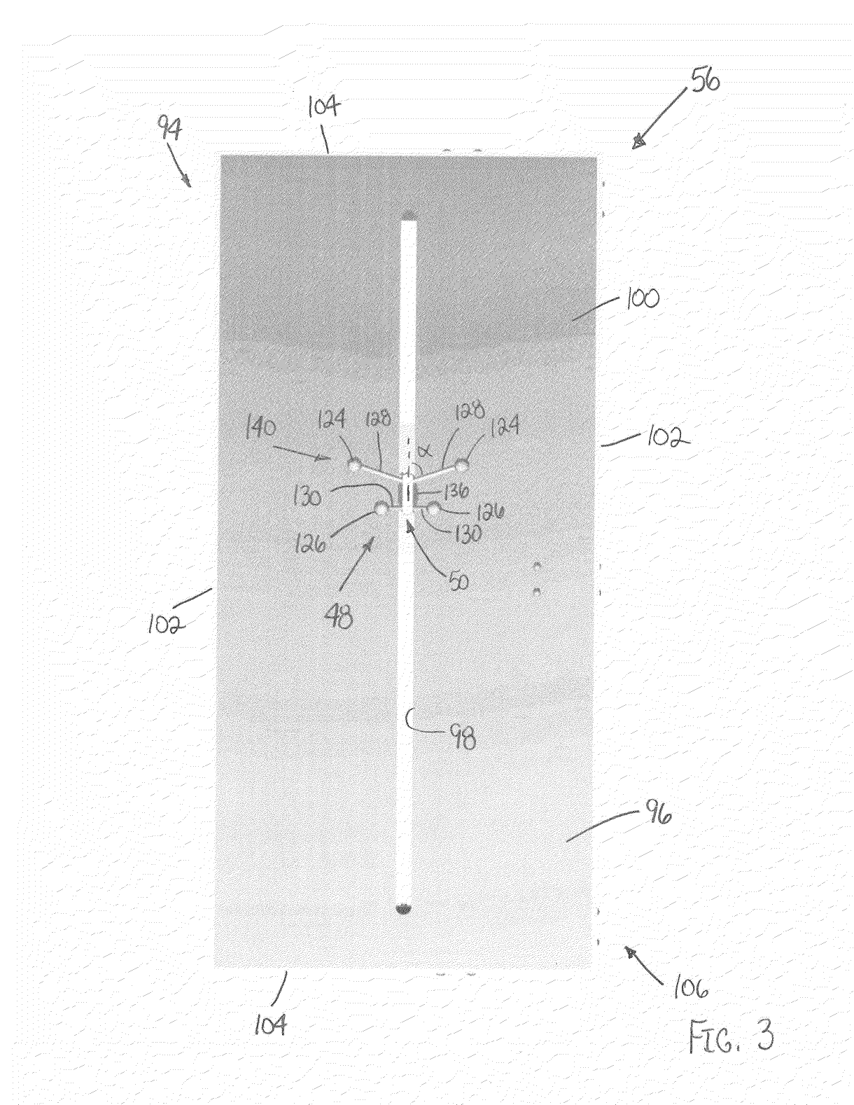

With continued reference to FIGS. 1 and 2 and additional reference to FIG. 3, the base 56 provides a foundation 94 for the massaging furniture 40, in this case a massaging bed 42, constructed in accordance with the present invention, to which the massager mounting arrangement 58 of the massaging system 44a and/or 44b is anchored or otherwise attached. The base 56 preferably also includes a platform 96 upon which the resilient person support 64 is disposed or overlies with the resilient person support 64 being removably attached or fixed to the platform 96 or another part of the base 56 if desired. Both the base 56 and the platform 96 can be and preferably are substantially rigid providing a substantially rigid load-supporting foundation 94 that defines a housing or enclosure 106 in which at least part of each massaging system 44a and/or 44b of the massaging furniture 40 is housed or enclosed.

As is best shown in FIG. 3, the platform 96 of the base 56 has an elongate longitudinally extending slot 98 through which the massager actuator arrangement upwardly extends with the platform providing a cover 100 overlying the massager mounting arrangement 58, massager guide 54 and massager carriage 52. The platform 96 is carried by at least one and preferably a plurality of sidewalls 102, 104 of the base 56 at least one and preferably a plurality of which provide buttresses to which at least a portion of the massager mounting arrangement 58 is attached.

With additional reference to FIGS. 4 and 5, where the massaging furniture 40 is a massaging bed 42, the platform 96 is substantially planar and generally horizontal providing a generally horizontal load-bearing person supporting surface upon which the mattress 80 or mattress assembly 82 is disposed. Where the massaging bed 42 employs a mattress 80, the mattress 80 is formed with an elongate slit 108 overlying and generally parallel to the elongate slot 98 formed in the platform 96 terminating in a pair of slit ends 110, 112 that terminate before respective head and foot ends of the mattress 80. Where the massaging bed 42 employs a mattress assembly 82, elongate slit 108′ extends to the opposite head and foot ends of the bed 42 with such an elongate 108′ slit formed by adjacent mattress blocks 84a and 84b disposed in abutment with each other.

With continued reference to FIG. 4, a plurality of mattress or mattress block anchors 115 can be disposed between the platform 96 and the bottom of the mattress 80 or the bottom of a respective mattress block(s) 84a, 84b, 84c and/or 84d where the bed 42 employs a mattress assembly 82. Each such anchor 115 can be in the form of a hook and loop fastener arrangement, such as VELCRO, disposed at various locations about or along the platform 96 to removably attach the mattress 80 and/or mattress blocks 84a, 84b, 84c and/or 84d of mattress assembly 82 to the platform 96 in a manner that prevents relative movement therebetween during use and operation.

FIG. 5 illustrates the massaging head 48 disposed in slit 108 formed in mattress 80 with one portion 114 of the massaging head arrangement 48 resiliently slidably supported by and on an outer resilient massager head suspension surface 116 of one side 118 of the mattress 80 and another portion 120 of the massaging head arrangement 48 resiliently slidably by and on the outer surface 116 of the other side 122 of the mattress 80. The massaging head arrangement 48 is of multi-lobed construction having at least a plurality of spaced apart lobes 124, 126 each carried by a respective one of a plurality of arms 128, 130 that extend outwardly from opposite sides 132, 134 of an elongate longitudinally extending massager head guide shoe 136 that rides along in a resilient and flexible guide channel 138 formed by the shoe 136 slidably moving in slit 108. The guide shoe 136 can have tapered or rounded ends and can extend below the top or outer resilient massager head suspension supporting surface 116 of the mattress 80 separating adjacent slit-forming sides in the mattress 80 during fore and/or aft movement of the head 48 in and/or along the slit 108 during massaging system operation.

Each massager head lobe 124, 126 provides a massaging action effector that preferably is of generally spherical and/or round construction to not only minimize friction when the massager head 48 is moving fore or aft toward or away from the head or foot of the massaging bed 42, but the generally spherical and/or round effector or lobe shape more efficiently and/or more uniformly transmits or communicates massaging wave(s), vibration(s), and/or motion or other displacement of the massaging action of the massaging head 48 to the resilient person support 64 overlying and above the head 48.

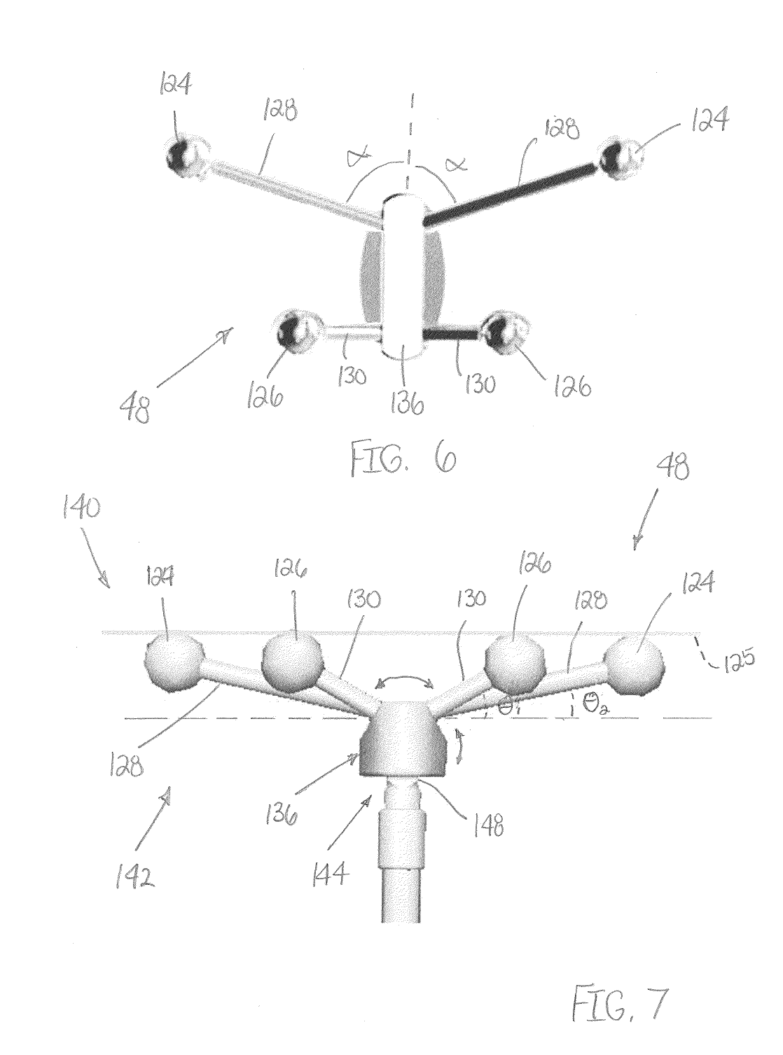

With additional reference to FIGS. 6 and 7, the massager head guide shoe 136 is elongate and longitudinally extending with each pair of upwardly angled massager effector lobe carrying arms 128, 130 angled at an acute angle, θ₁ and/or θ₂, relative to the generally planar generally horizontal top or outer resilient massager head suspension supporting surface 106 of the mattress. The fore arms 128 are obliquely angled relative to the shoe 136, i.e., acutely angled at an angle, α, relative to a longitudinal centerline of the shoe 136, toward the front 90 of the massaging bed 42 with the aft arms 130 being generally perpendicular to the shoe 136, such as is shown in FIGS. 3, 4 and 6. As is best shown in FIG. 6, the effectors or lobes 124 and 126 of the massager head 48 are tangent to a common plane depicted by line 125 in FIG. 6.

One pair of the arms 128 is longer than the other pair of the arms 130 defining a low friction suspension claw 140 that functions as a force spreader 142 that more uniformly distributes or spreads the force of the head 48 during massager suspension operation over a greater surface area of the top or outer resilient massager head suspension supporting surface 106 capturing the massager suspension spring 92 integrally formed by the portion of the mattress 80 resiliently supporting the claw 140 or head 48 in compression.

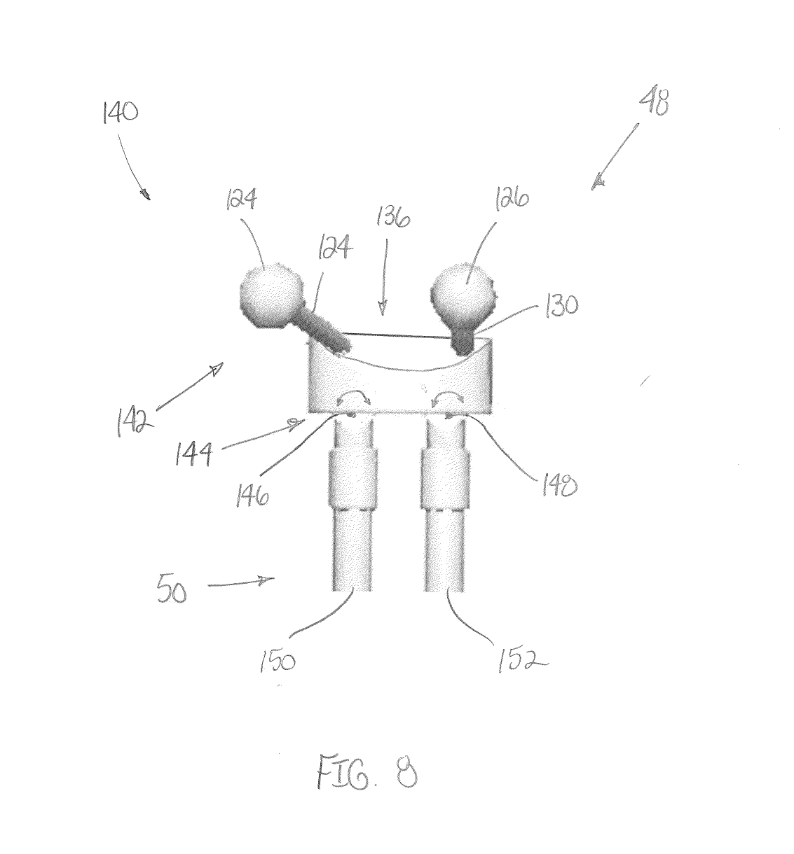

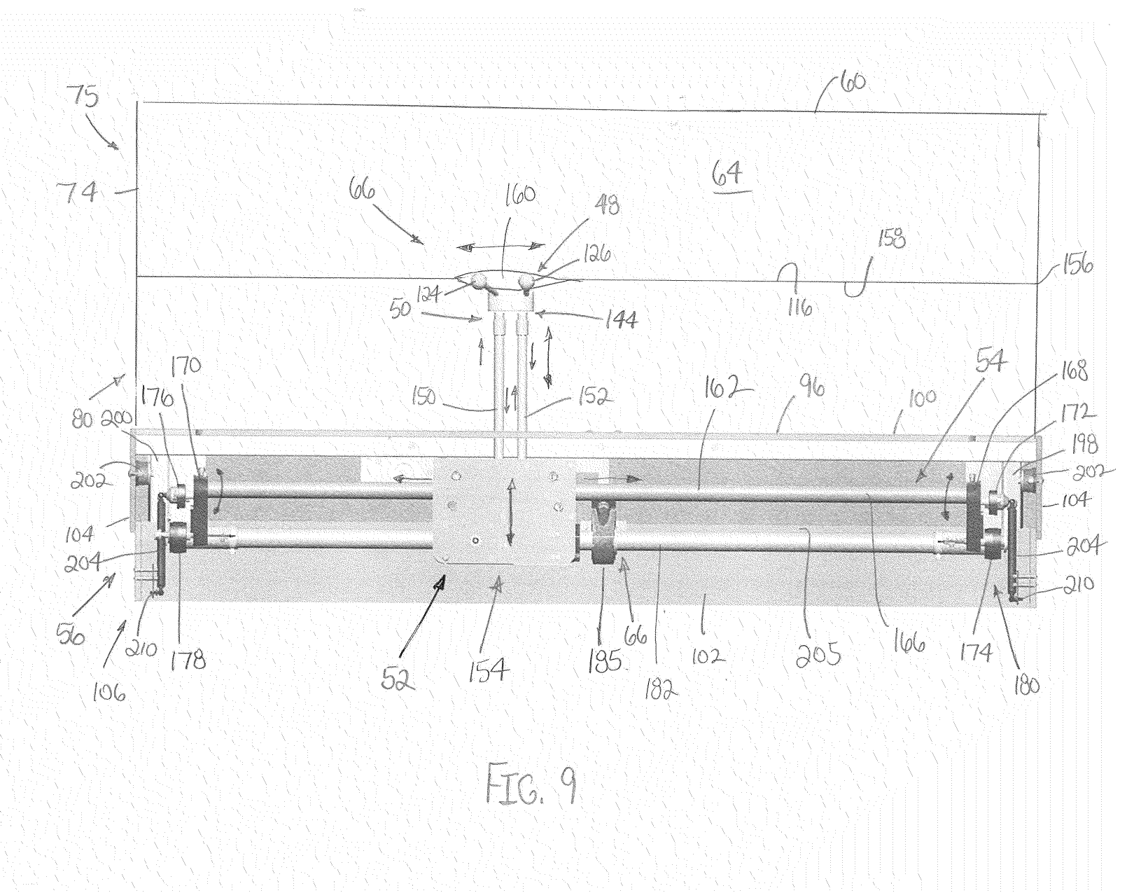

As is best shown in FIGS. 6-8, the massager head shoe 136 has an oblong or oval shape with a pair of rounded ends that more easily spread apart the sides of the slit 108 during massaging system operation. The shoe 136 is attached to one end of the massager actuator arrangement 50 by a pivot joint arrangement 144 that preferably enables the massager head 48 to pivot about at least one pivot axis and/or can be configured to pivot about plurality of degrees of freedom enabling the head 48 to laterally and/or longitudinally “float” as the head 48 travels along the slit 108. As is best shown in FIG. 8, the massager actuator arrangement 50 is attached to the shoe 136 of the massager head 48 by a pivot joint arrangement 144 having a pair of spaced apart pivot joints 146 and 148. As is best depicted in FIGS. 7 and 8, the pivot joints 146 and 148 pivotally attach the head 48 to the massager actuator arrangement 50 by fore and aft pivots to a fore end and an aft end of the shoe 136.

With continued reference to FIG. 8, the massager actuator arrangement 50 is formed of a pair of generally elongate massager actuators 150, 152 extending alongside one another that can be and preferably are generally parallel to each other with one of the actuators 150 being movable relative to the other one of the actuators 152. Each elongate massager actuator 150, 152 preferably is formed of an elongate rod that can be of tubular or hollow construction. With additional reference to FIGS. 9 and 10, each elongate massager actuator 150, 152 remotely communicates massaging action from a massager drive arrangement 154 disposed onboard the massager carriage 52 in the base 56 or foundation of the massaging bed 42 to the massager head 48.

As is shown in FIGS. 9 and 10, the massager head 48 longitudinally travels within a generally horizontal slit 156 formed between the upper resilient massager head suspension surface 116 of the mattress 80 (or mattress assembly 82) and a lower resilient massager head coupling surface 158 formed in or by the bottom or bottom surface of the resilient person support 64 disposed between the massager head 48 and the person supporting surface 60. As previously discussed, in one preferred massaging bed embodiment, both the resilient person support 64 and mattress 80 (or mattress assembly 82) are formed of memory foam with the resilient person support 64 being formed of part of the mattress 80 overlying the massager head 48 that can instead be a separate mattress pad or mattress topper 75 if desired. As is also shown in FIGS. 9 and 10, as the massager head 48 travels in a fore or aft direction between the foot 88 and the head 90 of the massaging bed 42, the horizontal slit 156 is separated by the massager head 48 creating a gap 160 between surfaces 116 and 158 that collapses after the head 48 such that the surfaces 116 and 158 contact each other once again. As is further shown in FIGS. 9 and 10, the opposed surfaces 116 and 158 are in contact with one another in front of the massage head 48 as well as behind the massage head 48 with the gap 160 separating the surfaces 116 and 158 traveling with the massage head 48 as it travels back and forth between the foot 88 of the bed 42 and the head 90 of the bed 42.

With continued reference to FIGS. 9 and 10, the massager carriage 52 rides generally horizontally and longitudinally along a massager guide 54 between fore and aft positions respectively adjacent the head 90 and foot 88 of the massaging bed 42 during selective movement of the massager head 48, such as fore-aft massager head movement initiated and/or controlled by a user of the massaging bed 42 (e.g., a person 44a laying or lying on the bed 42). The massager guide 54 includes a pair of spaced apart, generally parallel, longitudinally extending elongate guideways 162, 164 that extend through the massager carriage 52 carrying the carriage 52 on pairs of oppositely extending rollers 163, 165 in a manner permitting relative movement therebetween. Each guideway 162, 164 preferably is an elongate rail 166 that is of generally circular cross-section that can be an elongate rod or tube extending between a pair of spaced apart generally transversely extending yokes 168, 170 of a corresponding one of a plurality of pairs of guide arms 172 & 174 and 176 & 178 pivotally resiliently mounted to the base 56 of the foundation of the bed 42. The guide arms 172 & 174 and 176 & 178 form a four bar linkage arrangement 180 that is pivotally coupled by a torsion arm 185 to an elongate longitudinally extending anchor tube 182 to which another portion 184 of the massager suspension arrangement 66 is resiliently coupled by a torsion spring arrangement 186 having a torsion spring 188 linked to the carriage 52 by a torsion bar 195 biasing the carriage 52, guide 54 and head 48 upwardly toward the person supporting surface 60. The torsion spring arrangement 186 of the lower suspension 184 permits downward displacement of the carriage 52, guide 54 and head 48 when a person 44a laying on the person supporting surface 60 of the mattress 80 of the bed 42 sinks into the mattress 80. Cooperation between the lower suspension 184 and the upper suspension provided by the spring 92 formed by part of the mattress 80 provides a reverse or floating spring-type suspension arrangement that enables the massager head 48 to float in a plurality of degrees of freedom and/or along a plurality of axes to more smoothly follow the three-dimensional contour of a person 44a laying on the mattress 80 during massaging system operation.

The drive arrangement 154 includes a plurality of drives with at least one of the drives 194 driving the massager actuator arrangement 50 communicating massaging action in the form of massaging vibration(s), wave(s) and/or displacement(s) to the massager head 48 during massaging system operation and another one of the drives 196 being a massager carriage drive that moves the carriage 52 via a rail or belt 205 along the guideways 162, 164 fore and aft. The guide arms 172 & 174 and 176 & 178 are pivotally mounted by a pair of spaced apart anchor plates 198, 200 disposed on opposite ends of the base 56 of the bed 42 which are in turn mounted to walls 104 of the base 56 by a plurality of isolators 202 formed of an elastomeric vibration isolating and/or noise attenuating material that can be a rubber, a silicon rubber, a fluoropolymer elastomer, or another suitable flexible, resilient vibration dampening and/or noise attenuating material. The guide arms 172 & 174 and 176 & 178 are also pivotally coupled by at least one damper 204 to the anchor plates 198, 200 with one end of the damper 204 pivotably slidably received in a damper guide slot 210 configured to accommodate deflection of the guide arms 172 & 174 and 176 & 178 during massager suspension operation. The anchor tube 182 extends between the anchor plates 198, 200 and preferably is fixed thereto.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A system for massaging a person comprising:
(a) a base;
(b) a massager drive;
(c) a massager in operable cooperation with the massager drive; and
(d) a surface upon which a person is supported and massaged by the massager.

2. The massaging system of claim 1 further comprising a massager suspension resiliently supporting the massager permitting displacement of the massager relative to the person support surface generally toward or away from the person support surface (or movable relative to base toward or away from base).

3. The massaging system of claim 2 wherein the massager comprises a massager head that is embedded within a cushion underlying the person support surface.

4. The massaging system of claim 3 wherein the massager suspension is comprised of the cushion.

5. The massaging system of claim 2 wherein the massager suspension is comprised of a resiliently deformable material supporting part of the massager.

6. The massaging system of claim 2 further comprising a massager drive carriage carried by the base that is movable relative thereto, the massager carriage carrying the massager drive and the massager, and wherein the massager carriage is resiliently supported by the massager suspension.

7. The massaging system of claim 6 wherein the massager suspension is comprised of a linkage arrangement having at least a plurality of links cantilevered outwardly from a plurality of arms at least one of which is spring biased enabling displacement of the massager relative to the base toward or away from the base.

8. The massaging system of claim 2 wherein the massager suspension is comprised of a resiliently deformable material supporting part of the massager.

9. The massaging system of claim 8 wherein the resiliently deformable material is comprised of padding or a cushion.

10. The massaging system of claim 9 wherein the padding or cushion is comprised of foam.

11. The massaging system of claim 10 wherein the foam is comprised of memory foam.

12. The massaging system of claim 2 wherein the person supporting surface comprises a mattress, wherein the massager comprises a massager head embedded within the mattress, and wherein the massager suspension is comprised of the mattress.

13. The massaging system of claim 12 wherein the mattress has a portion underlying part of the massager head resiliently supporting the massager head permitting displacement of the massager head relative to the base toward or away from the base.

14. The massaging system of claim 1 further comprising a massager carriage carrying the massager, and a massager carriage guide carrying the massager carriage enabling movement of the massager carriage and massager relative to the person supporting surface and base.

15. The massaging system of claim 14 wherein the massager carriage guide is operably coupled to the base by a plurality of isolators.

16. The massaging system of claim 15 wherein each isolator comprises an isolating mount disposed between an anchor used to mount the massager carriage guide to the base and the base.

17. The massaging system of claim 16 wherein each isolating mount is comprised of a resilient and elastomeric material.

18. The massaging system of claim 17 wherein each isolating mount comprises a vibration isolating mount.

19. The massaging system of claim 17 wherein each isolating mount comprises a vibration dampening mount.

20. The massaging system of claim 17 wherein each isolating mount comprises a noise dampening mount.

21. The massaging system of claim 17 wherein each isolating mount comprises a noise reducing mount.

22. The massaging system of claim 17 wherein each isolating mount comprises a noise attenuating mount.

23. The massaging system of claim 17 wherein each isolating mount comprises a resonance preventing mount.

24. The massaging system of claim 16 wherein there are a plurality of anchors mounting the massager carriage guide to the base with one of the anchors comprising a first anchor plate disposed at or adjacent one end of the massager carriage guide and another one of the anchors comprising a second anchor plate disposed at or adjacent an opposite end of the massager carriage guide.

25. The massaging system of claim 24 wherein each one of the first and second anchor plates is mounted to the base by at least a plurality of the isolators.

26. The massaging system of claim 24 wherein each one of the first and second anchor plates is mounted to the base by a plurality of pairs of the isolators.

27. The massaging system of claim 24 wherein the base is comprised of at least one side and a plurality of ends, and wherein each one of the first and second anchor plates is mounted to one of the side and one of the ends of the base by at least one isolator.

28. The massaging system of claim 27 wherein each one of the first and second anchor plates is mounted to at least one of the side and one end of the base by a plurality of isolators.

29. The massaging system of claim 28 wherein each one of the first and second anchor plates are mounted to the side of the base by a plurality of isolators.

30. The massaging system of claim 14 wherein the massager carriage guide is operably coupled to the base by a plurality of dampers.

31. The massaging system of claim 30 wherein each damper comprises one of a dashpot and a shock absorber.

32. The massaging system of claim 30 wherein each damper comprises a tuned mass damper or harmonic absorber.

33. The massaging system of claim 14 further comprising a plurality of dampers in operable cooperation with the massager carriage guide and the base.

34. The massaging system of claim 33 wherein each damper comprises one of a dashpot and shock absorber

35. The massaging system of claim 33 wherein each damper comprises a tuned mass damper or harmonic absorber.

36. The massaging system of claim 14 further comprising a plurality of carriage guide support arms cantilevered outwardly from part of the base carrying the massager carriage guide, wherein the plurality of carriage guide support arms is movable relative to the base enabling displacement of the massager relative to one of the base and person support surface toward and away therefrom.

37. The massaging system of claim 36 wherein each one of the plurality of carriage guide support arms is pivotally operatively connected to the base enabling pivotal motion of the plurality of carriage support arms relative to the base to displace the massager relative to one of the base and person support surface toward and away therefrom.

38. The massaging system of claim 37 further comprising a suspension biasing arrangement in operable cooperation with one of the carriage guide and carriage guide support arms biasing the massager toward the person support surface and permitting displacement of the massager relative to the base away from the person support surface.

39. The massaging system of claim 38 wherein the suspension biasing arrangement comprises at least one biasing element.

40. The massaging system of claim 39 wherein the at least one biasing element comprises at least one of a torsion, compressible or tensile biasing element.

41. The massaging system of claim 40 wherein each biasing element comprises one of a torsion spring and coil spring.

42. The massaging system of claim 36 wherein the carriage guide comprises at least one elongate carriage guideway along which the massager carriage rides enabling movement of the massager relative to one of the base and person supporting surface.

43. The massaging system of claim 42 wherein the carriage guide comprises a pair of generally parallel carriage guideways upon which the massager carriage rides.

44. The massaging system of claim 43 wherein the massager carriage further comprises a massager carriage drive in operable cooperation with the carriage guide enabling the massager carriage to be moved in either direction along the guideways.

45. The massaging system of claim 44 wherein each carriage guideway comprises a rail and the massager carriage guide further comprises a roller rotatively riding along each rail.

46. The massaging system of claim 45 wherein each carriage guideway is rotatively supported by a pair of rollers straddling each rail of each guideway with one of the rollers disposed on one side of the rail of each guideway and the other one of the rollers disposed on an opposite side of the rail of each guideway.

47. The massaging system of claim 46 further comprising a plurality of spaced apart guideways yokes with one of the yokes disposed at or adjacent one end of the guideways and another one of the yokes disposed at or adjacent an opposite end of the guideways.

48. The massaging system of claim 47 further comprising a damper in operable cooperation with one of the yokes and the guideways and in operable cooperation with the base.

49. The massaging system of claim 47 further comprising a plurality of dampers each having one end in operable cooperation with one of the yokes and the guideways and another end in operable cooperation with the base.

50. The massaging system of claim 49 wherein one of the plurality of dampers is disposed at or adjacent one end of the guideways and another one of the plurality of dampers is disposed at or adjacent an opposite end of the guideways.

51. The massaging system of claim 50 wherein the one end of each one of the plurality of dampers is pivotably mounted at or adjacent one end to one of the yoke and guideways and is pivotably mounted at or adjacent an opposite end to the base.

52. The massaging system of claim 50 wherein one end of each one of the plurality of dampers is movably mounted to the base.

53. The massaging system of claim 52 wherein the one end of each one of the plurality of dampers is slidably mounted to the base.

54. The massaging system of claim 53 wherein the one end of each one of the plurality of dampers is slidably pivotably mounted to the base.
